(19) United States
(12) Patent Application Publication
(10) Pub. No.: US 2004/0239080 A1
(43) Pub. Date: Dec. 2, 2004

(54) Housing retention mechanism

(76) Inventors: Philip F. Berrahou, Rochester, MI (US); Jonathan L. Clarke, Berkley, MI (US); William R. Macdonald, Decker, MI (US)

Correspondence Address: DINNIN & DUNN, P.C., 2701 CAMBRIDGE COURT, STE. 500, AUBURN HILLS, MI, 48326, US

(21) Appl. No.: 10/448,512

(22) Filed: May 30, 2003

(51) Int. Cl. B60R 21/16

(52) U.S. Cl. 280/728.2

(57) ABSTRACT

The present invention provides an inflatable restraint system that includes a housing having a base plate with a central aperture and a periphery. A folded inflatable restraint cushion is positioned in the housing, as is a gas generator that is operable to supply an inflation gas to the inflatable restraint cushion. The base plate includes a plurality of integral hooked tabs extending from the base plate and having edges formed by a plurality of cuts in the base plate positioned inwardly of the periphery.

### TECHNICAL FIELD

The present invention relates generally to airbag housings and methods for airbag housing assembly, and more particularly to such a housing having a base plate with integrally formed retention tabs for securing the airbag housing with a vehicle steering wheel.

### BACKGROUND OF THE INVENTION

Modular airbag assemblies have become standard features on many vehicles. In a typical driver-side design, a housing is provided that retains a folded airbag and a gas generator that is operable to supply an inflation gas to the airbag. Various other components, for example, portions of the vehicle horn apparatus, can be attached to or included with the housing. One of the advantages of any modular component, but in particular components in the automotive industry, is that they can be produced, packaged and shipped ready to install in a vehicle. As such, it is often desirable to make the means for attaching the components in the vehicle as simple as possible, to facilitate activities at the assembly facility. Various methods have been proposed, some meeting with great success, for attaching airbag assemblies in vehicles.

Accompanying advances in mounting technology have been the competing interests of weight, ease of manufacture, and production costs. Simplicity in design and production has not always paralleled simplicity in the end product. For example, many airbag module attachment designs that provide snap-in or other relatively simple attachment means require extensive, complicated machining of the component parts necessary for attachment. Some of these designs also require numerous parts in addition to the base components of the module.

### SUMMARY OF THE INVENTION

It is an object of the present invention to provide an inflatable restraint system housing retention mechanism that is light in weight, simple in design, and relatively easy to assemble.

In accordance with this and other objects, the present invention provides a mounting arrangement for a housing for a vehicle inflatable restraint system that includes a substantially planar base plate or bottom panel having a central opening for receipt of a gas generator. A periphery of the base plate is adapted to attach to a portion of an airbag housing. A plurality of hooked tabs are integral with the base plate and formed intermediate the central opening and the periphery. The tabs are bent substantially normal to the base plate and adapted to secure the base plate to a mounting apparatus in a vehicle.

### BRIEF DESCRIPTION OF THE DRAWINGS

FIG. 1 is a perspective view of a base plate for an inflatable restraint system having retention tabs according to a preferred embodiment of the present invention;

FIG. 2 is a partial view of a base plate similar to FIG. 1;

FIG. 3 is a perspective view of a base plate for an inflatable restraint system having retention tabs according to a second preferred embodiment of the present invention;

FIG. 4 is a partial view of a base plate similar to FIG. 3;

FIG. 5 is a perspective view of a base plate for an inflatable restraint system having retention tabs according to a third preferred embodiment of the present invention;

FIG. 6 is a partial view of a base plate similar to FIG. 5.

### DETAILED DESCRIPTION OF PREFERRED EMBODIMENTS

Referring to FIG. 1, there is pictured a base plate 10 for use in an inflatable restraint assembly in a vehicle. Base plate 10 is preferably a component in the housing (not shown) for a conventional airbag system (also not shown). In a preferred embodiment, base plate 10 is utilized in an assembly having various additional panels or pieces that, in cooperation with base plate 10, form a container for storing a folded airbag and other system components. Typically, the container (not shown) is attached to a molded elastomeric covering, and base plate 10 forms the bottom of the container, preferably positioned immediately adjacent a vehicle steering wheel assembly, to which it is attached. The stored folded airbag may then be inflated to cushion the vehicle driver in the event of a crash. Although the disclosed base plate is contemplated for use in a driver-side airbag assembly, alternative embodiments are contemplated for passenger side applications. A horn mechanism may or may not be incorporated into the housing assembly. Base plate 10 is preferably metal, for example, steel or aluminum, and is formed with conventional metal fabrication equipment and by stamping and/or punching processes known in the art.

Base plate 10 is preferably a rigid substantially planar body formed from a unitary piece of sheet metal material having a main planar portion 11. A central aperture 12 is defined by base plate 10, and is located centrally in main planar portion 11. Aperture 11 is preferably circular, and can accommodate any conventional disk-shaped inflator when incorporated into the associated airbag housing. A plurality of fastening holes 14 are preferably positioned about aperture 12, and assist in positioning an inflator therein by receiving fasteners attached to or integral with the inflator. Base plate 10 is further characterized by a periphery 16, preferably comprising a wall 17 extending upwardly relative to planar portion 11. The wall 17 preferably includes a plurality of projections 18 of differing configurations. Several alternative types of projections 18 are pictured in FIG. 1, which serve various purposes such as retention of an airbag, attachment with other housing members, etc.

A plurality of integral hooked tabs 20 are formed from the same piece of housing material as base plate 10, and preferably positioned intermediate of periphery 16 and central aperture 12. As stated herein, the term “intermediate of” should be understood to encompass designs wherein the hooked tabs are formed independently of the outside or outboard edges of the base plate. Stated another way, stamping and/or cutting of the hooked tabs is not coextensive with portions of the periphery, but rather the cuts are formed inboard thereof. Such a design maintains the structural integrity of the base plate about its periphery, and allows the base plate to be designed having the various peripheral features described above without interference by the presence of the hooked tabs. Alternative embodiments are possible, however, in which the hooked tabs have common edges with the base plate periphery.

In one preferred embodiment, as shown in FIG. 1, two tabs 20 are provided, and are stamped or otherwise cut from planar portion 11. Referring in addition to FIG. 2, illustrating a close-up of a tab 20, each of the tabs of the FIG. 1 embodiment preferably comprises a plurality of free edges 21, 22 and 23, and an attached edge 24. Edge 21 is preferably a substantially linear longitudinal edge that extends from the attached edge 24 (preferably perpendicular to edge 21) to a distal edge 22, preferably also substantially linear, and oriented parallel to attached edge 24. Edge 23 preferably comprises a plurality of angled edges 23a, 23b, and 23c, that define a cutout region or hooked region 25 that engages with a complementary feature on the vehicle steering wheel, or a mounting assembly attached to the steering wheel. In the embodiment of FIG. 1, edge 23aslopes inwardly as it approaches edge 22. Thus, when incorporated into an inflatable restraint device apparatus, base plate 10 is the bottom panel of the airbag housing, and has mounting tabs 20 depending therefrom.

FIG. 1 further illustrates a molded covering 30 attached to a hooked tab 20. In a preferred embodiment, a resilient molded covering 30 is included on all the tabs, however, for clarity only one such covering is shown in FIG. 1, with the underlying hooked tab shown in phantom. The molded covering 30 may be formed from any suitable composition, many of which are known in the art, or by another suitable means. For instance, a flowable curable composition can be sprayed, painted or applied by some other means onto the tabs 20. Alternatively, a molded sleeve-type member can be pushed onto tabs 20, and slid into place. Any elastomeric formulation that provides sufficient strength, lubricity, stiffness, temperature performance and dimensional stability may be used for the molded covering. In a preferred embodiment, materials such as Dupont Rynite, and similar glass-filled nylon type 6 compositions may be used. Exemplary suppliers of suitable materials include: Dupont, of Wilmington, Del.; Toray Industries of New York, N.Y.; Clariant Corporation of Albion, Mich.; and Ticona of Summit, N.J. Because edge 23apreferably slopes toward distal edge 22, a complementary resilient sleeve member 30 can be relatively easily pushed onto the tab 20, but is relatively difficult to remove due to cut-out region 25, which allows an engagement between the molded covering and the tab 20 in a fashion similar to a snap-fit engagement. The preferably resilient molded covering facilitates retention of the base plate with its respective mounting apparatus with minimal rattling, since the resilient covering can absorb vehicle vibrations.

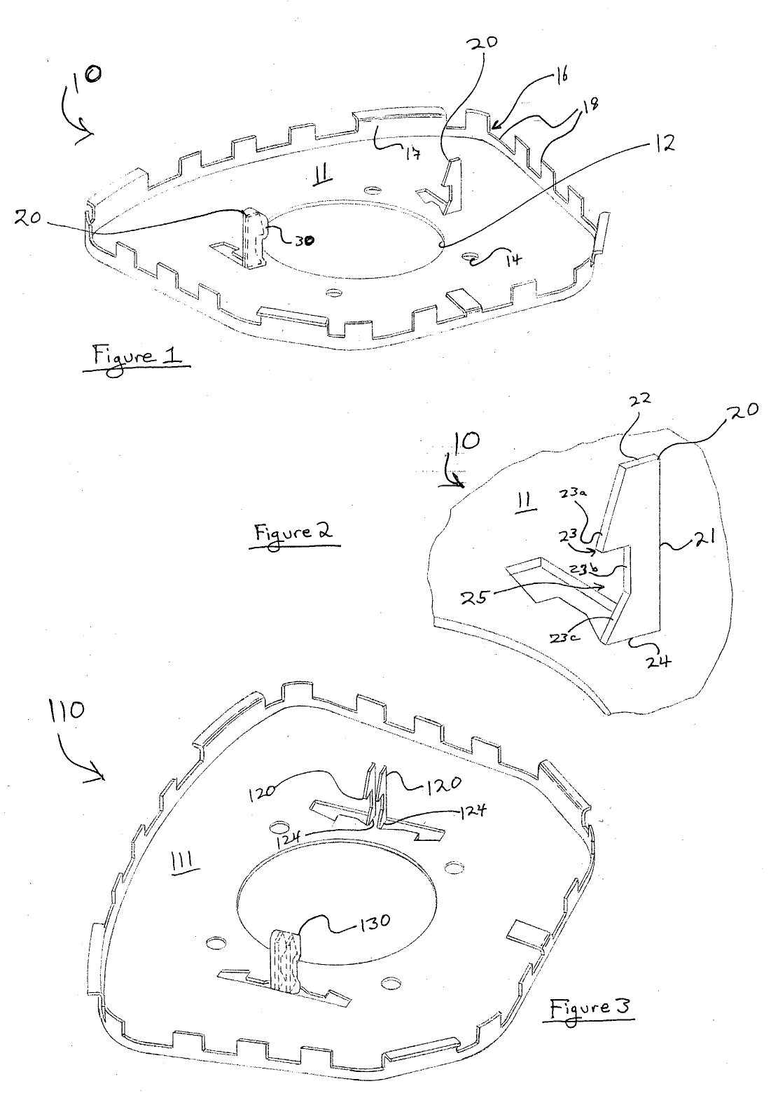

Turning to FIG. 3, there is shown another preferred embodiment of a base plate 110 according to a second preferred embodiment of the present invention. In the FIG. 3 embodiment, a plurality of tabs 120 are provided, and are preferably positioned in sets of two. The tabs 120 are preferably similar in configuration to the tabs of the FIG. 1 embodiment. The members of the sets of two preferably are formed from the base plate planar portion 111 such that they have attached edges 124 positioned proximate one another. Thus, when the respective tabs 120 are stamped/cut and bent perpendicular to the orientation of the base plate 110, they form a substantially mutually parallel set extending normal to the base plate. Similar to the FIG. 1 embodiment, the tabs 120 preferably have a molded covering 130. For certain applications, for example, where a wider hooking surface is desired, such as that provided by two tabs in parallel rather than single tabs, or a more robust tab is desired, the FIG. 3 embodiment may be particularly well suited. FIG. 4 illustrates a close-up view of the base plate 110 of FIG. 3, similar to the close-up view of FIG. 2.

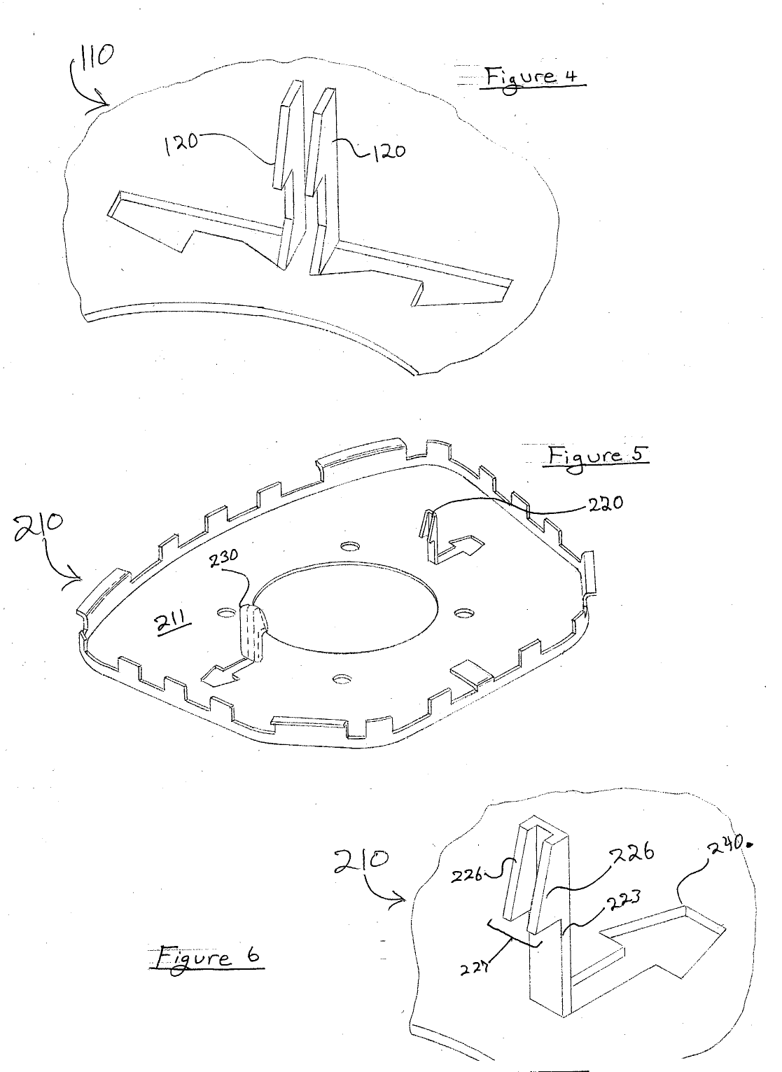

FIGS. 5 and 6 illustrate yet another preferred embodiment of a base plate 210 according to the present invention. The FIG. 5 embodiment is similar in many respects to the previously described embodiments, however, there are several distinctions. Base plate 210 includes a planar portion 211, with a plurality of integral tabs 220 extending therefrom. Similar to the foregoing embodiments, tabs 220 have a molded covering 230. However, in contrast to the foregoing embodiments, tabs 220 each preferably include a pair of distal ear portions 226 extending from lateral edges 223 of tabs 220. In a preferred embodiment, tabs 220 are punched or cut from planar portion 211 substantially in the shape shown by the peripheral outline 240 in FIG. 6. After the initial stamping/cutting, tabs 220 are bent upward to a position substantially perpendicular to planar portion 211, and distal ear portions 226 are bent substantially 90° from the orientation of tabs 220. This step forms a hook 227 that functions similar to the cutout regions described with regard to the foregoing embodiments. In particular, the hook(s) 227 (and the preferred molding(s) 230, not shown) facilitate(s) attachment between base plate 210 and the vehicle steering assembly.

Related to the foregoing constructed embodiments, the present invention provides a method of manufacturing an airbag module for an inflatable restraint assembly in a vehicle. The method includes the steps of providing a planar base plate 10 having a central aperture 12 for receipt of a gas generator (not shown) and a peripheral edge 16. The method further includes the step of forming a plurality of tab members 20 integral with the base plate 10. The tab members 20 include a plurality of free edges 21, 22, 23a, 23band 23cand an attached edge 24. Each of the free edges 21, 22, 23a, 23band 23care preferably formed by cuts in the base plate 10 inboard of the peripheral edge 16. The cuts rendering the respective free edges can be formed by conventional stamping, or some other means for metal cutting could be used. The method further includes the step of bending the plurality of tab members 20 at their attached edges 24 to an orientation substantially perpendicular to the planar base plate 10, and positioning a resilient covering 30 over the tab members 20. Alternative methods are contemplated, wherein base plates are formed in conformity with the preferred constructed embodiments disclosed herein. For instance, the embodiment of FIG. 4 might be manufactured by following steps similar to the foregoing, and further characterized by positioning sets of tabs in proximate, substantially parallel alignment. Similarly, the embodiment of FIG. 5 might be manufactured by following the foregoing steps, and further characterized by the step of forming and appropriately bending the distal ear portions to form the described embodiment.

By manufacturing a base plate for use in an airbag housing according to the foregoing, a relatively simple, light weight and easy to assemble device can be made. Compared to many earlier designs, for example those utilizing threaded attachments, the present invention is less expensive to manufacture. Moreover, by forming the tabs integrally with the base plate, the present design provides relatively high strength clips, and allows simple, snap-in attachment with a complementary base during vehicle assembly. In embodiments utilizing the molded coverings over the tabs, rattling of the airbag housing in the vehicle can be substantially reduced, as compared to many earlier designs. In a related vein, the molded covering in cooperation with an integral clip allows a resilient attachment means without the need for a separate metal part insert to reinforce the clip.

The present description is for illustrative purposes only, and should not be construed to limit the breadth of the present invention in any way. Thus, those skilled in the art will appreciate that various modifications could be made to the presently disclosed embodiments without departing from the spirit and scope of the present invention, defined in terms of the claims set forth below. Other aspects, features and advantages will be apparent upon an examination of the attached drawing figures and appended claims.

1. A driver side airbag housing comprising:
a substantially planar base plate having a central opening for receipt of a gas generator and a periphery;
a plurality of hooked tabs integral with said base plate and extending from a region thereof between said central opening and said periphery;
said tabs bent substantially normal to the base plate and adapted to secure said base plate to a mounting apparatus in a vehicle.

2. The airbag housing of claim 1 wherein said plurality of hooked tabs comprises sets of two tabs connected to said base plate at proximate edges and extending in parallel.

3. The airbag housing of claim 2 further comprising a resilient molding on said hooked tabs.

4. The airbag housing of claim 1 wherein said plurality of hooked tabs comprises tabs having distal ear portions extending from lateral edges of each tab and sloping toward distal ends thereof.

5. The airbag housing of claim 4 wherein said distal ear portions are bent substantially 90° from a plane defined by an orientation of said tabs.

6. The airbag housing of claim 1 further comprising a resilient molding on said hooked tabs.

7. The airbag housing of claim 6 wherein said molding is a flowable curable composition applied to said tabs and cured thereon.

8. The airbag housing of claim 6 wherein said molding is a hollow resilient sleeve slid onto and snap fitted on said tabs.

9. An inflatable restraint system comprising:
a folded inflatable restraint cushion;
a gas generator operable to supply an inflation gas to the inflatable restraint cushion;
a housing with a substantially planar base plate having a central aperture and a periphery, said base plate including a plurality of hooked tabs formed integrally therewith and positioned inboard said periphery;
wherein said hooked tabs extend from said base plate, thereby allowing snap in engagement of said inflatable restraint system with a mounting apparatus in a vehicle.

10. The restraint system of claim 9 wherein each of said hooked tabs comprises:
a planar tab member attached to and extending substantially normal to said base plate, said tab member having a substantially linear longitudinal edge, and a cutout opposite said longitudinal edge; and
a resilient molding on said tab member.

11. The restraint system of claim 10 wherein said plurality of integral hooked tabs comprises tabs positioned at opposite sides of said aperture, the cutout of each tab opening toward the aperture.

12. The restraint system of claim 9 wherein the base plate forms a bottom panel of said housing.

13. A method of manufacturing an airbag module for an inflatable restraint system in a vehicle comprising the steps of:
providing a planar base plate having a central aperture for receipt of a gas generator and a peripheral edge, the planar base plate adapted to attach to an airbag housing;
forming a plurality of tab members integral with the base plate, the tab members having a plurality of free edges and an attached edge, each of the free edges being formed by a cut in the base plate inboard of the peripheral edge;
bending the plurality of tab members at their attached edges to an orientation substantially perpendicular to the planar base plate;
positioning a resilient covering over the tab members.

14. The method of claim 13 wherein the step of forming a plurality of tab members comprises:
forming a plurality of distal ear portions on each of the tab members; and
bending the ear portions substantially 90°.

15. The method of claim 13 further comprising:
forming sets of two of the tabs with proximate attached edges; and
positioning the tabs in substantially parallel alignment.

16. The method of claim 13 wherein the step of forming a plurality of tab members integral with the base plate comprises:
forming one of the free edges of each tab from a cut in the base plate coextensive with the edge of the central aperture.

17. The method of claim 13 wherein the step of positioning a resilient covering over the tab members comprises applying a flowable curable material to the tab members and curing the material thereon.

18. The method of claim 13 wherein the step of positioning a resilient covering over the tab members comprises sliding a complementary sleeve over the tab member.

19. A driver side airbag housing comprising:
a plurality of attachable body panels forming a receptacle with an interior space for storing components of an inflatable restraint system;
wherein one of said body panels is a bottom panel, comprising the lower surface of the airbag housing and having a plurality of integral hooked tabs formed from said bottom panel and bent substantially normal thereto, at least one of said hooked tabs comprising ear portions bent relative to a body of said tab.

20. An airbag housing comprising:
a substantially planar base plate;
a plurality of hooked tabs formed integrally with said base plate, each of said hooked tabs having a substantially planar body portion and at least one ear portion bent transverse to said body portion.

21. The airbag housing of claim 20 comprising two ear portions at opposite sides of said body portion, said ear portions oriented substantially orthogonal to said body portion.

22. An airbag housing comprising:
a substantially planar base plate;
a pair of mounting tabs formed integrally with said base plate, said mounting tabs extending substantially in parallel and attached to said base plate at proximate attachment edges.

23. The airbag housing of claim 22 comprising an elastomeric covering positioned over said pair of mounting tabs.

24. The airbag housing of claim 23 wherein said elastomeric covering comprises an overmolded covering over both of said pair of mounting tabs.

25. The airbag housing of claim 23 wherein said elastomeric covering comprises an elastomeric sleeve positioned over said pair of mounting tabs, said elastomeric sleeve comprising a cutout facilitating a snap fit engagement with a mounting apparatus in a vehicle airbag system.
